(19) United States
(12) Patent Application Publication
(10) Pub. No.: US 2024/0380226 A1
(43) Pub. Date: Nov. 14, 2024

(54) LAPTOP CHARGER

(71) Applicant: Yuantai Innovative Enterprise Ltd., Taichung City (TW)

(72) Inventors: HONG-MING CHEN, Taichung City (TW); Yan Yu, New Taipei City (TW)

(21) Appl. No.: 18/315,546

(22) Filed: May 11, 2023

(51) Int. Cl. H02J 7/00; G06F 1/16; H02J 50/10; H02J 50/90

(52) U.S. Cl. CPC H02J 7/0044; G06F 1/1635; H02J 50/10; H02J 50/90

(57) ABSTRACT

A laptop charger has a main body, a charging cable, and a limiting board. The main body has a storage groove and a column extending from a bottom of the storage groove. The charging cable is configured to be wound around the column for being contained in the storage groove, and the limiting board is configured to be combined with the column to limit the charging cable in the storage groove. When the laptop charger is carried around with a laptop, the charging cable is limited and protected by the limiting board for convenience of storage and can be prevented from being bended, knotted, or even damaged. During charging, a redundant portion of the charging cable can be stored in the storage groove to prevent people from tripping over the charging cable, which improves safety during charging.

### BACKGROUND OF THE INVENTION

### 1. Field of the Invention

The present invention relates to a charger, and particularly to a laptop charger.

### 2. Description of Related Art

A conventional laptop charger normally has a charging cable, a transformer, a power plug, etc.; during charging, the transformer reduces the voltage of an alternating current, and then the alternating current is converted to a direct current; afterwards, the direct current is supplied to a laptop for charging via the charging cable.

However, in the conventional laptop charger, the transformer is cumbersome, and the charging cable has a great length. When the laptop is carried around with the conventional laptop charger, the charging cable is easily interfered by the transformer or other stuffs in a backpack to be bended or knotted and become difficult to be stored. Although a cable tie is normally attached with the conventional laptop charger to hold the charging cable together, storage effect of the cable tie may change according to how users hold the charging cable with the cable tie; moreover, the charging cable held by the cable tie still contacts the transformer or other stuffs in the backpack, i.e., the charging cable cannot be protected properly.

To overcome the shortcomings of the conventional laptop charger, the present invention tends to provide a laptop charger to mitigate or obviate the aforementioned problems.

### SUMMARY OF THE INVENTION

The main objective of the present invention is to provide a laptop charger that is configured to store its cable in its main body, prevents its cable from being interfered, and properly stores and protects its cable.

The laptop charger has a main body, a charging cable, a limiting board, a transforming module, and an input port. The main body has a storage groove recessed on the main body and a column extending from a bottom of the storage groove. The charging cable is configured to be wound around the column for being contained in the storage groove and has two opposite ends and a connector. One of the two opposite ends of the charging cable is connected to the main body, and the connector is disposed on the other one of the two opposite ends of the charging cable and is configured to be plugged into a charging port of a laptop. The limiting board is configured to be mounted to the column for limiting the charging cable in the storage groove. The transforming module is disposed inside the main body and is electrically connected to the charging cable. The input port is disposed on the main body, is electrically connected to the transforming module, and is configured to be electrically connected to a socket via a power supplying cable.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a laptop charger of a preferred embodiment in accordance with the present invention;

FIG. 2 is another perspective view of the laptop charger in FIG. 1;

FIG. 3 is an exploded view of the laptop charger in FIG. 1;

FIG. 4 is another exploded view of the laptop charger in FIG. 1, showing a charging cable of the laptop charger being expanded;

FIG. 5 is a system block diagram showing power supply of the laptop charger in FIG. 1;

FIG. 6 depicts different ports on the laptop charger in FIG. 1 configured for different connectors to be plugged in; and

FIGS. 7 to 9 depict the laptop charger in FIG. 1 being applied to wireless charging of a cellphone.

### DETAILED DESCRIPTION OF THE PREFERRED EMBODIMENT

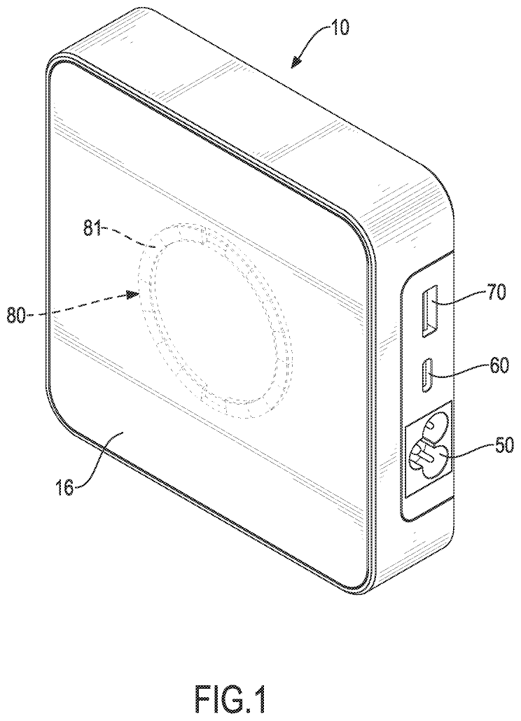

With reference to FIGS. 1, 3, and 5, the laptop charger of a preferred embodiment in accordance with the present invention has a main body 10, a charging cable 20, a limiting board 30, a transforming module 40, and an input port 50. The charging cable 20 is connected to the main body 10 and is storable in the main body 10. The limiting board 30 is configured to limit the charging cable 20 stored in the main body 10. The transforming module 40 is configured to reduce a voltage of a utility power supplied to the transforming module 40, and the utility power being an alternating current is converted to a direct current afterwards. The input port 50 is configured to be electrically connected to a socket supplying the utility power via a power supplying cable.

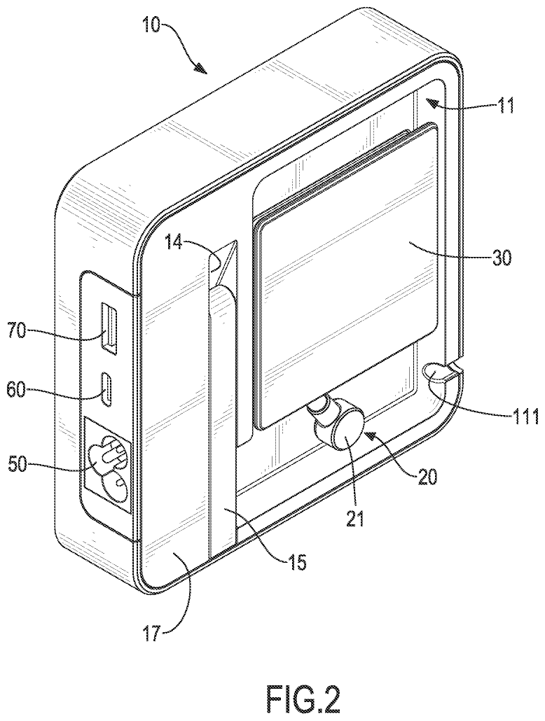

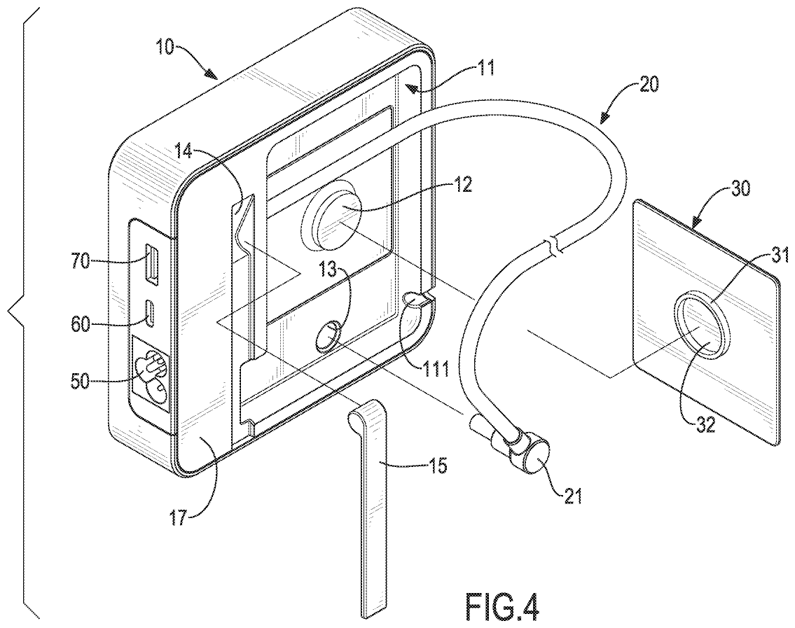

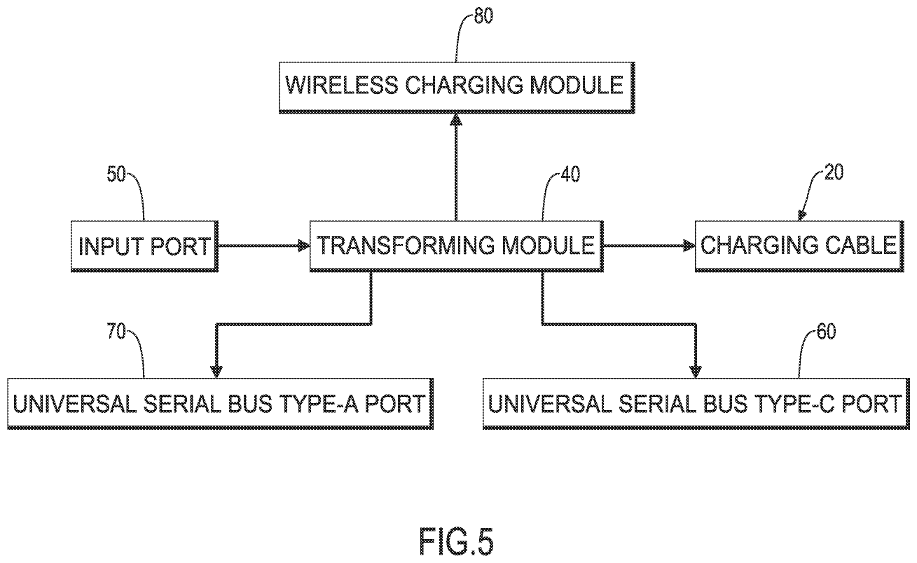

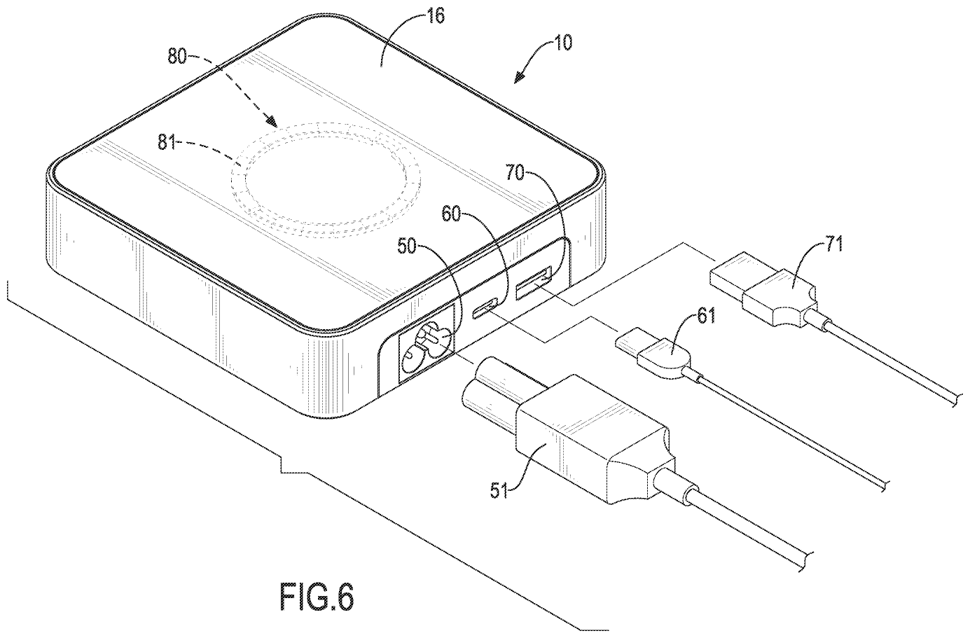

With reference to FIGS. 2 to 4, the main body 10 has a storage groove 11 recessed on the main body 10 and a column 12. Specifically, with reference to FIGS. 1 and 2, the main body 10 has a top surface 16 and a bottom surface 17 respectively facing two opposite directions, and with reference to FIG. 2, the storage groove 11 is recessed on the bottom surface 17 of the main body 10. With reference to FIG. 4, the column 12 extends upright from a bottom of the storage groove 11. With reference to FIG. 4, the charging cable 20 has two opposite ends and a connector 21; one of the two opposite ends of the charging cable 20 is connected to the main body 10, and the connector 21 is disposed on the other one of the two opposite ends of the charging cable 20 and is configured to be plugged in a charging port on a laptop. With reference to FIG. 5, the charging cable 20 is electrically connected to the transforming module 40, and the transforming module 40 is electrically connected to the input port 50; with reference to FIG. 6, a supplying connector 51 on one of two opposite ends of the power supplying cable is plugged in the input port 50, and a plug on the other one of the two opposite ends of the power supplying cable is plugged in a socket (not shown in figures). Thereby, the utility power is supplied to the transforming module 40 from the socket and through the power supplying cable and the input port 50, and a voltage of the utility power is reduced by the transforming module 40; afterwards, the utility power being an alternating current is converted to a direct current and is supplied to the laptop for charging by the charging cable 20.

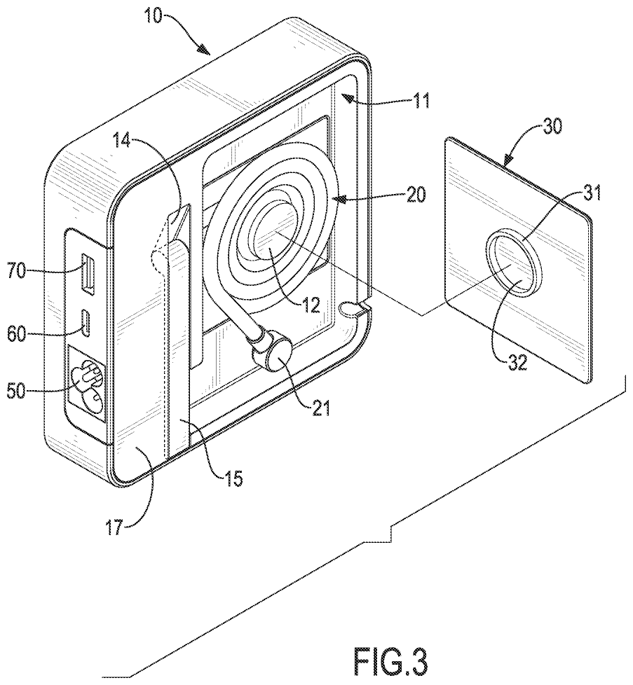

With reference to FIG. 3, the charging cable 20 is configured to be wound around the column 12 for being totally contained in the storage groove 11. With reference to FIGS. 2 and 3, the limiting board 30 is configured to be mounted to the column 12 for limiting the charging cable 20 in the storage groove 11. When bringing out the laptop charger, by the limiting board 30, the storage groove 11, and the column 12, the charging cable 20 can be stored in the main body 10. Specifically, the charging cable 20 can be swirlingly wound around the column 12 as shown in FIG. 3. When charging, the charging cable 20 can be expanded as shown in FIG. 4 and can be outstretched from the storage groove 11 to the laptop for the connector 21 to be plugged in the charging port on the laptop.

Moreover, after the connector 21 is plugged in the charging port on the laptop, the limiting board 30 limits a redundant portion of the charging cable 20 that is not outstretched from the storage groove 11 and limits the redundant portion of the charging cable 20 in the storage groove 11, which prevents the charging cable 20 from being scattered over different places on the floor and thus prevents people from tripping over the charging cable 20; the above configuration also prevents the charging cable 20 from easily being pulled, which thus prevents the connector 21 from being accidentally unplugged and damaged and prevents the laptop from being pulled and falling off.

The laptop charger of the present invention has the storage groove 11, the column 12, and the limiting board 30. When a laptop is carried around with the laptop charger, the charging cable 20 can be stored in the storage groove 11 and be limited and protected by the limiting board 30 first. The charging cable 20 is protected from being interfered by the transformer or other stuffs in a backpack to be bended, knotted, or even damaged. Thereby, the laptop charger of the present invention improves convenience of carrying around the laptop charger, properly protects the charging cable 20, and prolongs the service life of the charging cable 20. Moreover, when charging the laptop with the laptop charger of the present invention, the redundant portion of the charging cable 20 can be stored, which improves safety of charging.

With reference to FIGS. 3 and 4, in the preferred embodiment, the laptop charger has an engaging column 31 extending from one of two opposite surfaces of the limiting board 30 and an engaging groove 32 recessed on the engaging column 31. The engaging groove 32 is sheathed on and engaged with the column to allow the engaging column 31 to move along the column 12, and thereby, the limiting board 30 is connected to and configured to move relative to the column 12. Before expanding the charging cable 20 for charging the laptop or storing the charging cable 20 by winding the charging cable 20 around the column 12, the limiting board 30 can be pulled along a direction from the bottom of the storage groove 11 to a top opening of the storage groove 11 for the convenience of operating the charging cable 20; after the connector 21 is plugged in the charging port on the laptop or the charging cable 20 is completely received in the storage groove 11, the limiting board 30 is pushed back and covers the top opening of the storage groove 11 again to limit and protect the charging cable 20.

In other embodiments, the limiting board 30 may be magnetically combined with the column 12 and is configured to be detached from the column 12 for the convenience of expanding the charging cable 20, or the limiting board 30 may be combined with the column 12 via bolts; the embodiments described above are still configured to limit and protect the charging cable 20 by the limiting board 30. Thereby, configuration of how the limiting board 30 is combined with the column 12 is not limited to the preferred embodiment.

With reference to FIG. 4, in the preferred embodiment, the main body 10 has a connector hole 13 recessed on the bottom of the storage groove 11, spaced from the column 12, and being insertable for the connector 21 of the charging cable 20. After the charging cable 20 is wound around the column 12, the connector 21 can be inserted into the connector hole 13 for storage, which prevents the connector 21 from swinging in the storage groove 11 to be damaged. In the embodiment of the limiting board 30 being magnetically combined with the column 12, the connector hole 13 for the connector 21 to be inserted into prevents the connector 21 from contacting the limiting board 30 or the column 12 configured for magnetic attraction, which avoids dysfunction of the connector 21 and further prolongs the service life of the connector 21.

With reference to FIG. 4, in the preferred embodiment, the storage groove 11 further has a notch 111 recessed on a groove wall of the storage groove 11. When the charging cable 20 is expanded and outstretched from the storage groove 11 for charging the laptop, a portion of the charging cable 20 can be contained and held in the notch 11; i.e., the charging cable 20 extends outward from the storage groove 11 through the notch 111, which prevents the charging cable 20 from being pressed under the main body 20, prevents the charging cable 20 from being bended after a period of use, and further prolongs the service life of the charging cable 20.

With reference to FIGS. 1, 2, and 5, in the preferred embodiment, the laptop charger further has two output ports respectively being a USB Type-C port 60 (Universal Serial Bus Type-C port) and a USB Type-A port 70 (Universal Serial Bus Type-A port). The USB Type-C port 60 and the USB Type-A port 70 are both disposed on the main body 10 and are both electrically connected to the transforming module 40. With reference to FIG. 6, in use, the USB Type-C port 60 is configured for a USB Type-C connector 61 on one of two opposite ends of a charging wire to be plugged in, and the USB Type-A port 70 is configured for a USB Type-A connector 71 on one of two opposite ends of another charging wire to be plugged in. After the transforming module 40 reduces the voltage of an alternating current, the alternating current is converted to a direct current, and then the direct current can be supplied to an electronic apparatus connected to the other one of two opposite ends of said charging wire through the USB Type-C port 60 (or the USB Type-A port 70) and said charging wire. Thereby, the laptop charger of the preferred embodiment is not only capable of charging a laptop but also capable of supplying a direct current to the USB Type-C port 60 or the USB Type-A port 70 for charging other electronic apparatuses (e.g. cellphone). Thereby, the laptop charger is multifunctional and is convenient for a user to charge different electronic apparatuses without being restricted by the number of sockets at the venue, and also is free from the incident of forgetting to carry around the charging plug.

In the preferred embodiment, the laptop charger has two output ports respectively being the USB Type-C port 60 and the USB Type-A port 70. In other embodiments, the laptop charger may have only one said output port, and said output port may be another type of port for charging. As long as the laptop charger has at least one said output port electrically connected to the transforming module 40, a corresponding connector of said charging wire can be plugged in said output port for the convenience of charging other electronic apparatus. Thereby, configuration and number of said output port are not limited to the preferred embodiment.

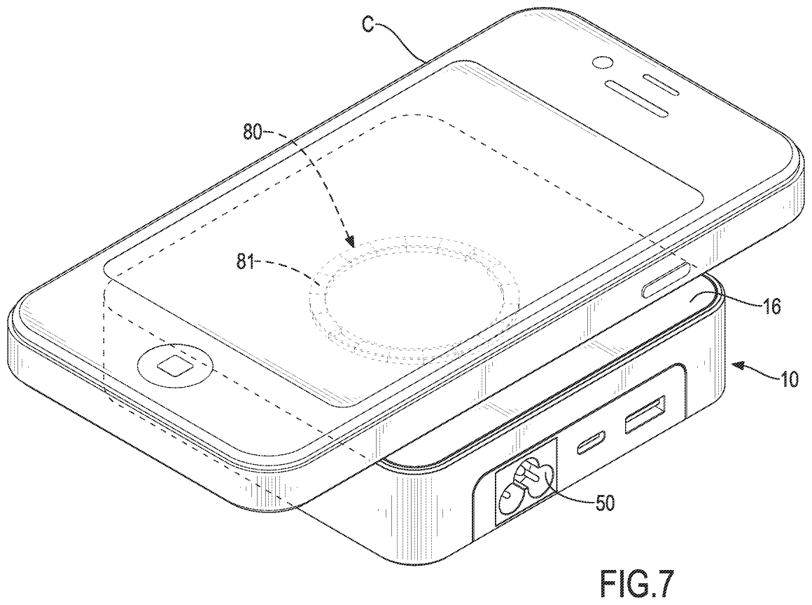

With reference to FIGS. 1 and 5, in the preferred embodiment, the laptop charger further has a wireless charging module 80 electrically connected to the input port 50 through the transforming module 40. The wireless charging module 80 is disposed inside the main body 10 and near the top surface 16 of the main body 10. The storage groove 11 recessed on the bottom surface 17 of the main body 10 is configured for storage of the charging cable 20, and the top surface 16 is a flat surface and is configured for an electronic apparatus to be placed on for charging by the wireless charging module 80. With reference to FIG. 7, for example, the laptop charger is configured for wireless charging of a cellphone C. The wireless charging module 80 further improves the functionality of the laptop charger.

Specifically, after an alternating current is supplied to the transforming module 40 through the input port 50 for reducing the voltage of the alternating current, the alternating current can be supplied to the wireless charging module 80. The wireless charging module 80 is configured to generate a changing magnetic field by change of direction or magnitude of a current supplied to loops of the wireless charging module 80, and i.e., the wireless charging module 80 can generate the changing magnetic field by supplying an alternating current or a direct current; then, the changing magnetic field induces an electric current in loops disposed inside the cellphone C to charge the cellphone C. In other embodiments, the wireless charging module 80 may be electrically connected to the input port 50 directly and is configured to reduce the voltage of a current supplied to the wireless charging module 80 by a transforming circuit of the wireless charging module 80. Detailed components, operating principle, and corresponding construction of the wireless charging module 80 may adopt any conventional wireless charger and are not limited to any specific configuration. In the figures, the wireless charging module 80 disposed inside the main body 10 is shown as a disk drawn in broken line only for better understanding but not for limiting specific shape and location of the wireless charging module 80.

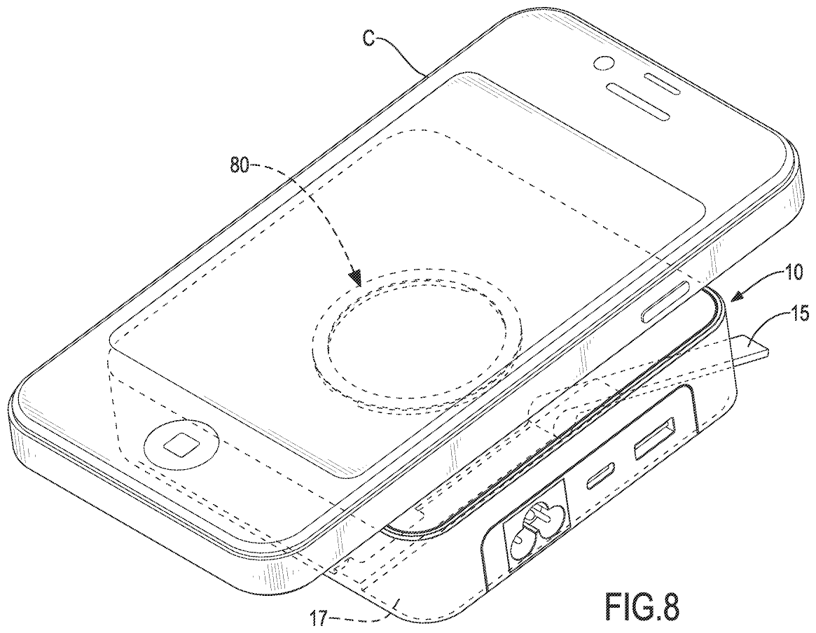

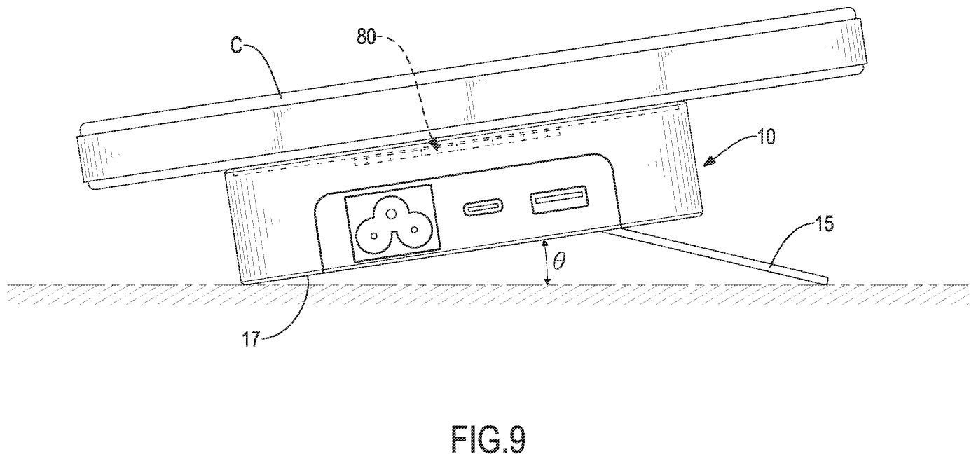

With reference to FIGS. 2 to 4, in the preferred embodiment, the laptop charger further has a rod containing groove 14 and a supporting rod 15. The rod containing groove 14 is recessed on the bottom surface 17 of the main body 10, and the supporting rod 15 is pivotally connected to the main body 10; the supporting rod 15 is configured to pivot relative to the main body 10 to be contained in the rod containing groove 14 as shown in FIGS. 2 and 3 or obliquely protrude from the bottom surface 17 of the main body 10 as shown in FIG. 8. With reference to FIGS. 8 and 9, when the cellphone C is wirelessly charged by the wireless charging module 80 of the laptop charger, by the supporting rod 15 pivoting and obliquely protruding from the bottom surface 17 of the main body 10, the main body 10 and a flat surface (e.g. desktop) have an oblique angle θ defined therebetween, and i.e., the cellphone C placed on the top surface 16 of the main body 10 is obliquely lifted by the supporting rod 15 together with the main body 10. Compared to placing the cellphone C horizontally, the cellphone C obliquely lifted is more convenient for the user to watch a screen of the cellphone C.

Furthermore, in the preferred embodiment, the wireless charging module 80 has a magnetically attracting element 81. The magnetically attracting element 81 is specifically an annular magnet and is configured to magnetically attract the cellphone C to be stably attached to the top surface 16 of the main body 10; thereby, when the cellphone C is obliquely lifted by the supporting rod 15, the cellphone C does not slide downward and can be stably attached to the top surface 16 of the main body 10 to be placed at an angle that is convenient for the user to watch the screen of the cellphone C. In other applications, the wireless charging module 80 may have different types or numbers of said magnetically attracting element 81; as long as the wireless charging module 80 has at least one magnetically attracting element 81 to magnetically attract electronic apparatuses to be stably attached to the top surface 16 of the main body 10 during wireless charging, number and configuration of said magnetically attracting element 81 is not limited to the preferred embodiment.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

1. A laptop charger comprising:
a main body having
a storage groove recessed on the main body; and
a column extending from a bottom of the storage groove;
a charging cable configured to be wound around the column for being received in the storage groove and having
two opposite ends, and one of the two opposite ends of the charging cable connected to the main body; and
a connector disposed on the other one of the two opposite ends of the charging cable and configured to be plugged into a charging port of a laptop;
a limiting board configured to be mounted to the column for limiting the charging cable in the storage groove;
a transforming module disposed inside the main body and electrically connected to the charging cable; and
an input port disposed on the main body, electrically connected to the transforming module, and configured to be electrically connected to a socket via a power supplying cable.

2. The laptop charger as claimed in claim 1, wherein the laptop charger comprises
an engaging column extending from the limiting board; and
an engaging groove recessed on the engaging column and sheathed on the column for the limiting board to be movably combined with the column.

3. The laptop charger as claimed in claim 1, wherein the limiting board is magnetically combined with the column.

4. The laptop charger as claimed in claim 1, wherein the main body has a connector hole recessed on the bottom of the storage groove, spaced from the column, and being insertable for the connector of the charging cable.

5. The laptop charger as claimed in claim 2, wherein the main body has a connector hole recessed on the bottom of the storage groove, spaced from the column, and being insertable for the connector of the charging cable.

6. The laptop charger as claimed in claim 3, wherein the main body has a connector hole recessed on the bottom of the storage groove, spaced from the 9 column, and being insertable for the connector of the charging cable.

7. The laptop charger as claimed in claim 1, wherein the storage groove has a notch recessed on a groove wall of the storage groove and configured for a portion of the charging cable to be received and held in the notch.

8. The laptop charger as claimed in claim 2, wherein the storage groove has a notch recessed on a groove wall of the storage groove and configured for a portion of the charging cable to be received and held in the notch.

9. The laptop charger as claimed in claim 3, wherein the storage groove has a notch recessed on a groove wall of the storage groove and configured for a portion of the charging cable to be received and held in the notch.

10. The laptop charger as claimed in claim 1, wherein
the laptop charger comprises a wireless charging module electrically connected to the input port;
the main body has a top surface and a bottom surface respectively facing two opposite directions;
the storage groove is recessed on the bottom surface of the main body; and
the wireless charging module is disposed inside the main body and near the top surface of the main body.

11. The laptop charger as claimed in claim 10, wherein the laptop charger comprises
a rod containing groove recessed on the bottom surface of the main body; and
a supporting rod connected to the main body and configured to pivot relative to the main body to be contained in the rod containing groove or obliquely protrude from the bottom surface of the main body.

12. The laptop charger as claimed in claim 11, wherein the wireless charging module has at least one magnetically attracting element configured to magnetically attract an electronic apparatus to be attached to the top surface of the main body.

13. The laptop charger as claimed in claim 1, wherein the laptop charger comprises at least one output port disposed on the main body and electrically connected to the transforming module.

14. The laptop charger as claimed in claim 2, wherein the laptop charger comprises at least one output port disposed on the main body and electrically connected to the transforming module.

15. The laptop charger as claimed in claim 3, wherein the laptop charger comprises at least one output port disposed on the main body and electrically connected to the transforming module.

16. The laptop charger as claimed in claim 13, wherein the laptop charger comprises two said output ports respectively being a USB Type-A port and a USB Type-C port.

17. The laptop charger as claimed in claim 14, wherein the laptop charger comprises two said output ports respectively being a USB Type-A port and a USB Type-C port.

18. The laptop charger as claimed in claim 15, wherein the laptop charger comprises two said output ports respectively being a USB Type-A port and a USB Type-C port.
